(19) United States
(12) Patent Application Publication
(10) Pub. No.: US 2014/0300543 A1
(43) Pub. Date: Oct. 9, 2014

(54) TOUCH PAD INPUT METHOD AND INPUT DEVICE

(71) Applicants: Itvers Co., Ltd., Seoul (KR); Intellectual Discoverly Co., Ltd., Seoul (KR)

(72) Inventors: Youn Soo KIM, Seoul (KR); Jiyoung KWON, Anyang-si (KR)

(73) Assignees: Itvers Co., Ltd., Seoul (KR); Intellectual Discoverly Co., Ltd., Seoul (KR)

(21) Appl. No.: 14/242,970

(22) Filed: Apr. 2, 2014

(30) Foreign Application Priority Data
Apr. 5, 2013 (KR) 10-2013-0037426
Apr. 30, 2013 (KR) 10-2013-0048549
Apr. 30, 2013 (KR) 10-2013-0048569

(51) Int. Cl. G06F 3/0354

(52) U.S. Cl. CPC G06F 3/03547
USPC 345/157

(57) ABSTRACT

Provided is a touch pad input method and input device. The touch pad input method includes touching a first point of a touch surface of a touch pad, touching a second point of the touch surface, and operating a direction key based on a relative position of the first point and the second point.

### CROSS-REFERENCE TO RELATED APPLICATION

This application claims priority to and the benefit of Korean Patent Application No. 10-2013-0037426 filed on Apr. 5, 2013, Korean Patent Application No. 10-2013-0048549 filed on Apr. 30, 2013, and Korean Patent Application No. 10-2013-0048569 filed on Apr. 30, 2013, the disclosure of which is incorporated herein by reference in its entirety.

### BACKGROUND

1. Field of the Invention

The present invention relates to a touch pad input method and input device, and more particularly, to a touch pad input method and input device in which direction key operating signals as well as mouse pointing and scrolling can be simultaneously implemented in a touch pad, the entire area of the touch pad can be scrolled when dragged, and a moving speed of a cursor can be set differently in accordance with a drag signal applying pattern when drag signals are consecutively applied two or more times.

2. Discussion of Related Art

Various kinds of display devices which provide information to users such as mobile terminals, laptops, smart phones, smart pads, remote controllers of TV, smart TVs, and the like have been used. An input device such as a touch panel, a touch pad, an input key, or the like is mounted in these display devices so that information input to a display screen can be performed.

User interface (UI) characteristics of a smart TV or an android set-top box among these display devices are that direction keys and a mouse cursor are used in near the same proportion. In a case of the smart TV, contents are arranged in the form of icons and sizes of icons disposed on a large-sized screen are larger than sizes of icons of PC, and therefore horizontal or vertical movement of the icons may be used more easily and conveniently through the direction keys, compared to a mouse cover method in which coordinates are moved one by one.

Therefore, in a case of the remote controller, the direction keys and a mouse input device are mounted together, and UI is disposed so as to diversely implement cursor signals, scroll signals, and direction key movement signals even in various contents.

In a case of the laptop, UI is formed as a separate section such as a relatively large-sized keyboard including a touch pad and direction keys. Demands for simultaneously implementing pointing, scrolling, and direction keys within such a touch pad of the laptop are gradually increased, but it is difficult to simultaneously implement cursor movement signals, scroll movement signals, and even the direction keys in a single touch pad without collision between the cursor movement signals and the scroll movement signals.

As described above, a touch pad input device having the conventional configuration places a mouse cursor on a corresponding list or icon to select the corresponding list or icon through an operation of tapping a touch pad when operating the mouse cursor using the touch pad, but there arises a problem that an unnecessary list or icon is selected when a user unintentionally touches the touch pad.

In addition, even when a finger is brought into contact with the touch pad after slightly separated from the touch pad during dragging, list or icon selection is likely to be executed against user's intention. In addition, a remote controller in which mouse movement is operated by a touch pad and list or icon selection is executed by a separate button has been suggested, but there is difficulty in alternately operating the touch pad and the button using a single finger.

In addition, in recent years, an interface of the smart TV or the android set-top box is disposed so as to enable screen scrolling to be performed horizontally and vertically in the same manner, and therefore, when a vertical scroll region and a horizontal scroll region are simultaneously allocated in a small area of the touch pad, a general pointing region is reduced to cause inconvenience during movement of the cursor. In addition, when long screen movement is required to be performed at the time of scrolling in accordance with contents, the scroll region is required to be repeatedly touched.

Furthermore, it is difficult to move the cursor from one end of a display unit to the other end thereof at a time due to a limitation of the size of the touch pad.

In order to solve such inconvenience, a method for accelerating a moving speed of the cursor in accordance with a dragging speed is currently utilized. That is, movement of the cursor is accelerated when the dragging speed is increased while the same distance is dragged, and therefore the cursor can be moved to farther distances.

However, in the above-described case, the cursor is difficult to be accurately placed on an accurate position due to a significantly high speed of the cursor, and the cursor cannot be moved at a reference speed or less (moving speed of the cursor when starting initial dragging) so that there is a limitation in delicate adjustment of the cursor.

### SUMMARY OF THE INVENTION

The present invention is directed to a touch pad input method and input device in which direction key functions may be executed in a touch pad without collision therebetween, and mouse pointing, scrolling, and direction key operations may be simultaneously implemented in the touch pad by dividing regions based on an initial touch point so that operations may be more freely performed.

The present invention is directed to a touch pad input method and input device in which the entire area of the touch pad may be allocated as a cursor movement mode when cursor movement signals are generated, and the entire area may be allocated as a scroll movement mode when scroll movement signals are generated.

The present invention is directed to a touch pad input method and input device in which a moving speed of a cursor may be increased and reduced through increase and decrease in a dragging speed, and the moving speed of the cursor may be set differently in accordance with a drag pattern even when dragging is performed at the same speed.

According to an aspect of a first embodiment of the present invention, there is provided a touch pad input method including: touching a first point of a touch surface of a touch pad; touching a second point of the touch surface; and operating a direction key based on a relative position of the first point and the second point.

The touching of the first point may include converting a current mode to a direction key input mode by touching the first point, and setting the direction key operated for each direction with respect to the first point. Here, when the touching of the second point is performed within a region in a set direction, the direction key corresponding to the direction may be operated.

Also, the touch pad input method may further include operating, when touch of another point is additionally performed after the touching of the second point, the direction key based on a relative position of the additionally touched point and a touch point immediately before the additionally touched point.

Also, the direction key may be set to move a cursor vertically and horizontally with respect to the first point.

Also, the direction key may be set to execute increase and decrease in a channel and a volume horizontally and vertically with respect to the first point.

Also, the operating of the direction key may be consecutively performed when another touch is performed within a predetermined region with respect to at least one of the first point and the second point within a preset time.

Also, the direction key may be operated faster than when touching the second point when dragging is performed within the region in the set direction instead of touching the second point.

Also, the operating of the direction key by the previous dragging may be consecutively performed when dragging is performed again within a certain time in a state in which the touch on the touch surface of the touch pad is canceled to complete dragging.

Also, an operating speed of the direction key may be increased and decreased based on a time for which the touching of the second point is maintained.

Also, when a switch capable of recognizing a click is mounted on a bottom surface of the touch pad, click signals and tap signals may be separately generated in accordance with ON/OFF signals of the switch.

According to another aspect of the first embodiment of the invention, there is provided a touch pad input method including: touching, by direction keys operated for each of a plurality of divided regions, a first point being one point of the divided region of a touch surface of a predetermined touch pad so that the direction key corresponding to a region in which the first point is touched is operated; and touching a second point of the touch surface so that the direction key set based on a relative position of the first point and the second point is operated.

According to an aspect of a second embodiment of the invention, there is provided a touch pad input method including: determining, by a position calculation unit, a contact position on a touch pad; determining a direction of primary dragging when the contact position is in a scroll region and performing a scroll function to correspond to the direction of primary dragging when the direction of primary dragging coincides with a longitudinal direction of the scroll region; and determining a direction of secondary dragging input in connection with the primary dragging and maintaining a current scroll direction when the direction of secondary dragging has a vector component in a direction perpendicular to the direction of primary dragging.

The determining of the direction of primary dragging and the determining of the direction of secondary dragging may perform the scroll function even when the primary dragging and the secondary dragging are deviated from the scroll region.

Also, the touch pad input method may further include determining a direction of tertiary dragging input in connection with the secondary dragging after the determining of the direction of secondary dragging.

Also, when the direction of tertiary dragging has a vector component in a direction perpendicular to the direction of secondary dragging, the determining of the direction of tertiary dragging may maintain the current scroll direction.

Also, when the direction of tertiary dragging has a vector component in a direction opposite to the direction of secondary dragging, the determining of tertiary dragging may perform the scroll function in an opposite direction.

Also, the determining of the contact position may perform a cursor movement function when the contact position on the touch pad is deviated from the scroll region.

Also, the determining of the contact position may continuously perform the cursor movement function even when the contact position on the touch pad is included in the scroll region.

Also, the scroll region may include a horizontal scroll region and a vertical scroll region.

According to an aspect of a third embodiment of the invention, there is provided a touch pad input method including: inputting primary dragging in a drag signal input unit; moving, by a control unit, a cursor output to an output unit in accordance with a first increase/decrease rate allocated to the primary dragging; inputting secondary dragging in the drag signal input unit after the primary dragging is completed; sensing, by a time sensing unit, a time interval (hereinafter, abbreviated as “drag pause period”) between an end time point of the primary dragging and a start time point of the secondary dragging and determining, by the control unit, whether a length of the drag pause period is in a predetermined setting range; and moving, by the control unit, the cursor in accordance with a second increase/decrease rate allocated to the secondary dragging when the length of the drag pause period is in the setting range, and moving the cursor in accordance with the first increase/decrease rate when the length of the drag pause period is out of the setting range.

The second increase/decrease rate may be set to be lower than the first increase/decrease rate.

The control unit may determine that the primary dragging is completed when the primary dragging is performed and then stopped in a state in which a contact means is brought into contact with the drag signal input unit, or determine that the primary dragging is completed when the primary dragging is performed and then the contact means is spaced apart from the drag signal input unit.

The touch pad input method may further include: applying tertiary dragging to the drag signal input unit when the secondary dragging is completed; sensing, by the time sensing unit, a time interval (hereinafter, abbreviated as “additional drag pause period”) between an end time point of the secondary dragging and a start time point of the tertiary dragging, and determining, by the control unit, whether a length of the additional drag pause period is in a predetermined setting range; and moving, by the control unit, the cursor in accordance with a third increase/decrease rate allocated to the tertiary dragging when the length of the additional drag pause period is in the setting range and moving the cursor in accordance with the second increase/decrease rate when the length of the drag pause period is out of the setting range.

Here, the second increase/decrease rate may be set to be lower than the first increase/decrease rate, and the third increase/decrease rate may be set to be lower than the second increase/decrease rate.

Also, the control unit may determine that the secondary dragging is completed when the secondary dragging is performed and then stopped in a state in which the contact means is brought into contact with the drag signal input unit, or determine that the secondary dragging is completed when the secondary dragging is performed and then the contact means is spaced apart from the drag signal input unit.

Also, a moving speed of the cursor may be accelerated in accordance with acceleration of a dragging speed, and an acceleration rate of the moving speed of the cursor may be set to be larger than an acceleration rate of the dragging speed.

Also, in a case in which the dragging is started from a center portion of the drag signal input unit and a case in which the dragging is started from a peripheral portion of the drag signal input unit, an increase/decrease rate for determining the moving speed of the cursor may be set differently.

Also, an increase/decrease rate of the moving speed of the cursor when the dragging is started from the center portion of the drag signal input unit may be set to be lower than an increase/decrease rate of the moving speed of the cursor when the dragging is started from the peripheral portion of the drag signal input unit.

The setting range may be configured to be changed by a user.

According to an aspect of a third embodiment of the present invention, there is provided a touch pad input device including: an output unit in which a cursor is output; a drag signal input unit that receives drag signals; a time sensing unit that senses a time interval (hereinafter, abbreviated as “drag pause period”) between an end time point of primary dragging and a start time point of secondary dragging; and a control unit that outputs cursor movement signals in accordance with drag signals input through the drag signal input unit, and outputs the cursor movement signals so that the cursor is moved in accordance with a first increase/decrease rate when a length of the drag pause period is in a predetermined setting range and the cursor is moved in accordance with a second increase/decrease rate different from the first increase/decrease rate when the length of the drag pause period is out of the setting range.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a flowchart illustrating an example of a touch pad input method according to a first embodiment of the present invention;

FIG. 2 is a flowchart illustrating another example of a touch pad input method according to a first embodiment of the present invention;

FIG. 3 is a diagram illustrating an operation state of a touch pad according to a first embodiment of the present invention;

FIG. 4 is a diagram illustrating another operation state of a touch pad according to a first embodiment of the present invention;

FIG. 5 is a diagram illustrating still another operation state of a touch pad according to a first embodiment of the present invention;

FIG. 6 is a cross-sectional diagram illustrating an inside of a touch pad according to a first embodiment of the present invention;

FIG. 7 is a diagram illustrating a touch pad in a touch pad input method according to a second embodiment of the present invention;

FIG. 8 is a diagram illustrating a state in which primary dragging is performed in a touch pad input method according to a second embodiment of the present invention;

FIG. 9 is a diagram illustrating a state in which secondary dragging is performed in a touch pad input method according to a second embodiment of the present invention;

FIG. 10 is a diagram illustrating a state in which tertiary dragging is performed in a touch pad input method according to a second embodiment of the present invention;

FIG. 11 is a diagram illustrating an example in which horizontal scrolling is performed in a touch pad input method according to a second embodiment of the present invention;

FIG. 12 is a flowchart illustrating a touch pad input method by a touch pad input device according to a third embodiment of the present invention;

FIG. 13 is a block diagram illustrating a touch pad input method by a touch pad input device according to a third embodiment of the present invention;

FIGS. 14 to 17 are diagrams illustrating a cursor movement process in accordance with a touch pad input method by a touch pad input device according to a third embodiment of the present invention;

FIG. 18 is a flowchart illustrating another example of a touch pad input method by a touch pad input device according to a third embodiment of the present invention; and

FIGS. 19 and 20 are diagrams illustrating another cursor movement process in accordance with a touch pad input method by a touch pad input device according to a third embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

### First Embodiment

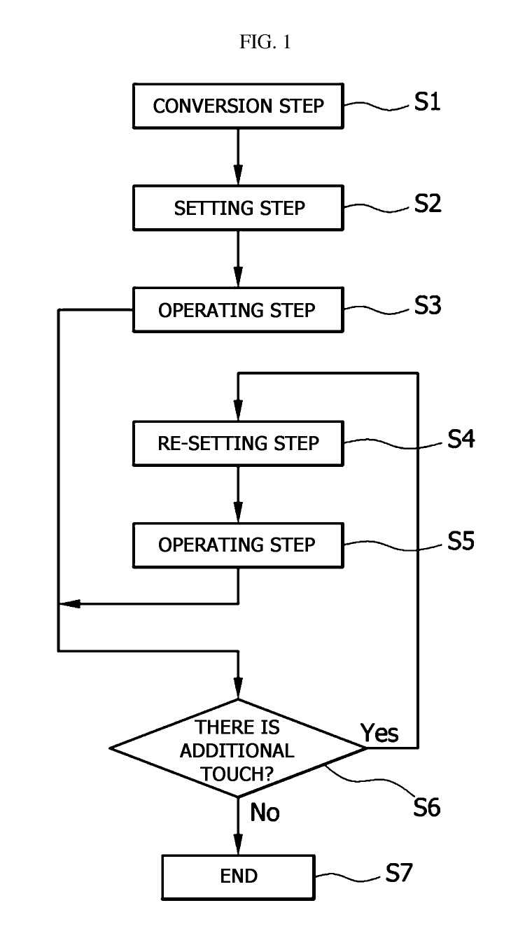

Hereinafter, the touch pad input method and input device according to a first embodiment of the present invention will be described with reference to FIGS. 1 to 6.

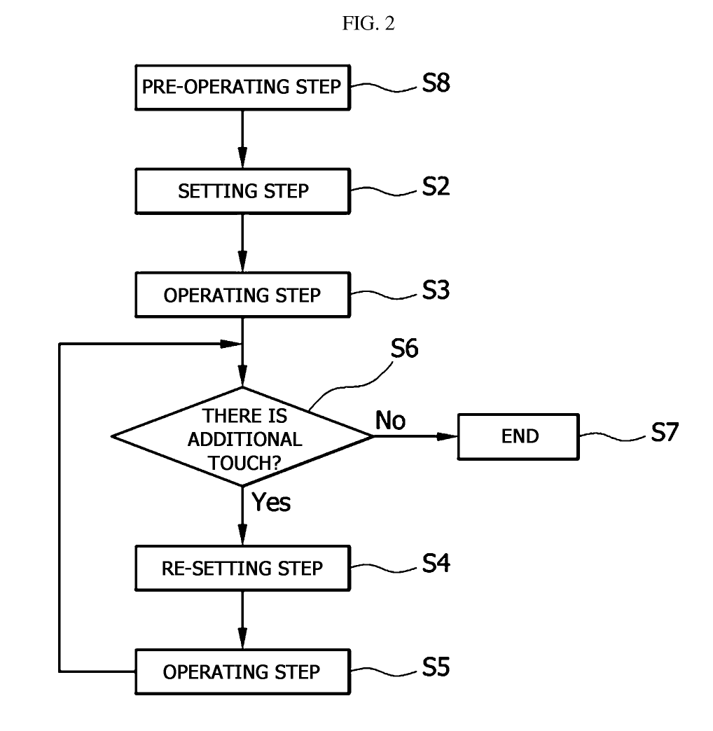

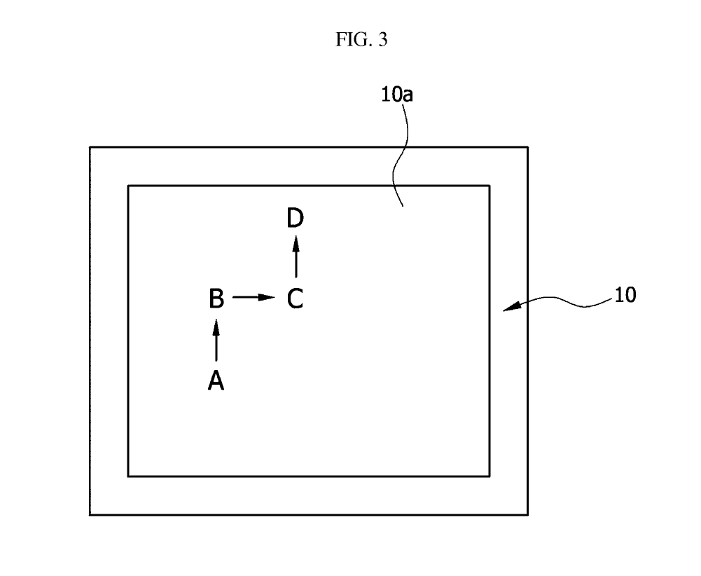

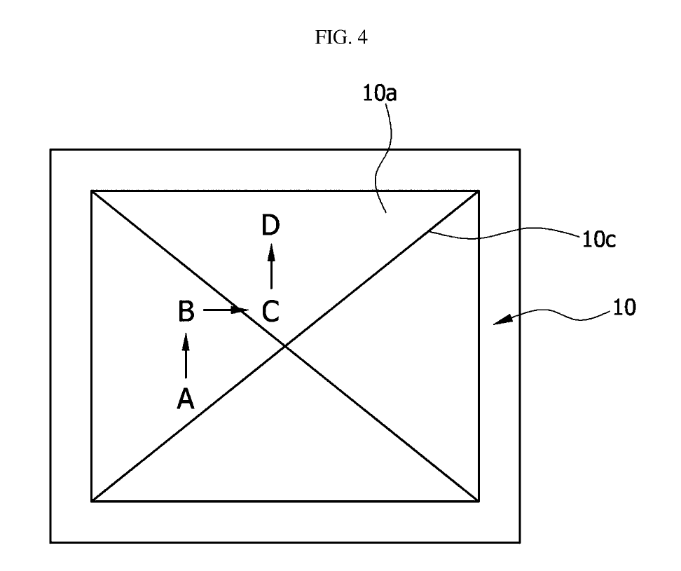

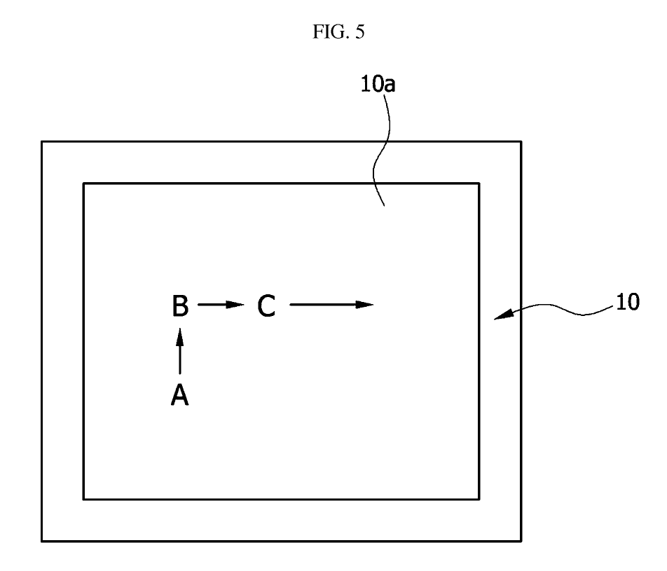

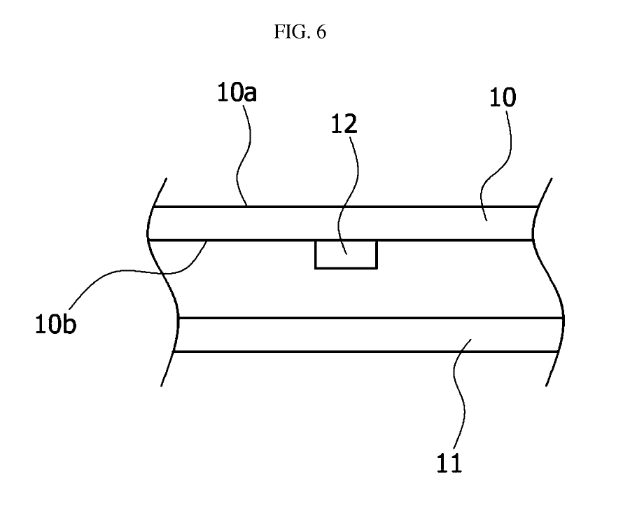

FIG. 1 is a flowchart illustrating an example of a touch pad input method according to a first embodiment of the present invention, FIG. 2 is a flowchart illustrating another example of a touch pad input method according to a first embodiment of the present invention, FIG. 3 is a diagram illustrating an operation state of a touch pad according to a first embodiment of the present invention, FIG. 4 is a diagram illustrating another operation state of a touch pad according to a first embodiment of the present invention, FIG. 5 is a diagram illustrating still another operation state of a touch pad according to a first embodiment of the present invention, and FIG. 6 is a cross-sectional diagram illustrating an inside of a touch pad according to a first embodiment of the present invention.

As shown in FIGS. 1 to 6, the touch pad input device according to the first embodiment of the present invention includes a touch pad 10 that is coupled to an upper surface of a housing 11 with a reception portion provided at one side thereof and includes a touch surface 10a formed on an upper surface thereof, a switch 12 that is mounted on a bottom surface 10b of the touch pad 10 and generates on signals while being brought into contact with a bottom surface of the housing 11 when a downward external force of a reference value or more is applied to the touch pad 10, and a restoration means (not shown) that is provided between the touch pad 10 and the housing 11 so as to elastically support the bottom surface of the touch pad 10 upwardly.

On the touch surface 10a of the touch pad, a division line 10c which is divided into at least two regions is displayed, and a direction key is designated for each of the divided regions. The region is preferably divided into four regions as shown in FIG. 4, and in this instance, the designated direction key may be set so as to vertically and horizontally move a cursor shown on a screen or to perform increase/decrease of a channel and a volume horizontally and vertically.

Such an input device of the present invention may be used in various kinds of display devices which provide information to users such as mobile terminals, laptops, smart phones, smart pads, remote controllers of TV, smart TVs, and the like, but in the present invention, an example in which the input device is used in the smart TV will be described.

As shown in FIGS. 1 and 3, an example of the touch pad input method according to the first embodiment of the present invention configured as above includes a converting step S1 of converting a current mode into a direction key input mode by touching a first point of the touch surface 10a which is formed on one side of the touch pad 10, a setting step S2 of setting a direction key operated for each direction with respect to the first point, an operating step S3 of operating the direction key corresponding to a set direction when a touch of the second point is performed within a region in the set direction, a determining step S6 of selecting to perform a completing step S7 of determining whether an additional touch is performed after the operating step S3 and completing input when the no additional touch is performed, a re-setting step S4 of re-setting the direction key operated for each direction with respect to a touch point immediately before an additionally touched point when a touch of another point is additionally performed after the touch of the second point, and an operating step S5 of operating the direction key corresponding to the region in the set direction after the re-setting step S4. After the operating step S5, the touch pad input method may proceed to the determining step S6 again.

As shown in FIG. 3, when touching a B point being an arbitrary second point above an A point being a first point at which a touch is initially performed, an upward direction key is operated, when touching a C point being an arbitrary third point positioned on the right side of the B point, a right direction key is operated, and when touching a D point being an arbitrary fourth point above the C point, the upward direction key is operated. Even when the B point and the D point are located in totally different positions, the same upward direction key is operated.

As shown in FIGS. 2 and 4, another example of the touch pad input method according to the first embodiment of the present invention configured as above includes a pre-operating step S8 of touching, by a direction key operated for each of a plurality of divided regions, a first point that is one point of a predetermined divided region of the touch surface 10a of the touch pad 10 so that the direction key corresponding to the region is operated, a setting step S2 of setting again the direction key operated for each direction with respect to the first point, an operating step S3 of operating the direction key corresponding to a direction in which a touch of a second point is performed when the touch of the second point is performed within a region in a direction set in the setting step S2, a determining step S6 of selecting to perform a completing step S7 of determining whether an additional touch is performed after the operating step S3 and completing input when no additional touch is performed, a re-setting step S4 of re-setting the direction key operated for each direction with respect to a touch point immediately before an additional touch is performed when a touch of another point is additionally performed after the touch of the second point in the determining step S6, and an operating step S5 of operating the direction key corresponding to a region in a direction set after the re-setting step S4. After the operating step S5, the touch pad input method may proceed to the determining step S6 again.

As shown in FIG. 4, at the moment when an A point being a first point at which a touch is initially performed is touched, the direction key designated in each region divided by a division line in advance is operated to operate a left direction key, when touching a B point being an arbitrary second point above the A point, an upward direction key is operated, when touching a C point being an arbitrary third point at the right side of the B point, a right direction key is operated, and when touching an arbitrary D point above the C point, the upward direction key is operated. Even when the B point and the D point are located in totally different positions, the same direction key is operated.

In the example of the touch pad input method according to the first embodiment described above, the direction key set in the setting step S2 may be set to move the cursor vertically or horizontally with respect to a touch point, and the direction key set in the setting step S2 may be set to perform an increase/decrease of a channel and a volume vertically or horizontally with respect to the touch point.

In addition, in the operating step S3, when another touch is performed within a predetermined range with respect to a touched point within a predetermined time, the corresponding direction key may be consecutively operated, and when dragging is performed in the region in the set direction instead of touching a predetermined point, the corresponding direction key may be operated faster than when touching the predetermined point. In this instance, when dragging is performed again within a predetermined time in a state in which dragging is completed by canceling a contact on the touch surface 10a of the touch pad 10, the direction key by previous dragging is consecutively performed.

In addition, in the operating step S3, an operating speed of the corresponding direction key is increased and decreased in accordance with a time for which the contact on the touch surface 10a is maintained.

In addition, when the switch 12 capable of recognizing a click is mounted on the bottom surface of the touch pad 10, in the operating of the direction key corresponding to the direction, click signals and tap signals are separately generated in accordance with ON/OFF signals of the switch 12. In this instance, click denotes an operation of an execution key operated when the switch is turned to an ON state by vertically applying an external force to the touch pad, and tap collectively denotes an input method performed while gently touching a touch surface of a touch pad provided in a laptop once or twice.

As described above, the touch pad input method according to the first embodiment is distinguished into two different methods. This is because there is no need to set a location of the direction key in advance because the region of the touch direction key in an existing absolute coordinate method have been already divided and displayed on the touch pad surface, but definition matching the relative coordinate method is required in a software manner because the direction key in the relative coordinate method according to the present invention is set with respect to an initial touch point in the setting step S2 or the re-setting step S4.

The example of the touch pad input method according to the first embodiment of the present invention is a method of allocating an initial touch point as a reference point, and the other example of the touch pad input method according to the first embodiment of the present invention is a method in which four divided regions are provided with respect to a center point of a touch pad, and a predetermined direction key is operated in a corresponding region immediately when a touch is initially performed in one region of the four divided regions.

A difference between the other example of the touch pad input method and the input method of direction keys in the existing absolute coordinate method is that the same direction key can be continuously operated in different directions even within a predetermined region with respect to the reference point.

In such two input methods, when an additional touch is performed within a separation location set in advance, direction key input signals in the same direction are generated. That is, when an additional touch is performed within a separation distance (for example, 5 mm) set in advance, the same direction key signals as the direction key input immediately when a touch is performed even in any direction are allocated. On the other hand, when an additional touch is performed in a position deviated from the separation distance set in advance, direction key setting position signals corresponding to a touched region after the additional touch are generated.

In addition, in the two methods described above, when a touch state is maintained after a touch is applied, consecutive direction key input signals are generated. That is, when a short touch is performed, operation signals are generated once, and when one-touch is performed multiple times, operation signals are generated once again. However, when a long touch is performed, consecutive direction key movement in a specific direction is performed. Thus, the moving speed of the direction key may be adjusted in accordance with a time for which a touch is maintained.

In addition, in the example and the other example of the touch pad input method described above, touch may be tap signals or click signals. In this case, direction key movement and selection signals are distinguished from each other. Here, when a tap is the direction key, a click may be operated as a selection key, and when a click is the direction key, a tap may be operated as the selection key.

Thus, in the same manner in which consecutive direction key movement signals are generated when a long tap is performed, a program may be configured so that consecutive direction key signals are generated when a long click is performed in a case in which the click is direction key signals.

In addition, in the direction key signals described above, when a selection signal method is configured in a different way, for example, when another surface of the touch pad or a specific display button portion is allocated, direction key speed signals may be disposed in more various ways. That is, in a case in which the direction key is continuously moved while a tap state is consecutively maintained, when signals are changed from tap to click, an existing direction key movement speed may be changed. For example, when tap is performed once in change of a channel, movement is performed in units of 1, 2, 3, . . . , when tap is maintained, movement of the direction key is performed in units of 10, 20, 30, . . . , and when tap is converted into click signals, movement thereof is performed in units of 100, 200, 300, . . . . In this case, there is an advantage that several hundreds of channels can be operated significantly quickly. Obviously, even when the direction key corresponding to click is moved, the similar method may be used. In this case, one-time click signals, long click signals, and long tap signals are respectively allocated, whereby various speed adjustments of the operation signals may be possible.

As shown in FIG. 5, when touching the C point and then quickly performing dragging to the right side, the right direction key is operated, and signals allocated to the right direction key, for example, movement of a channel or a menu bar may be quickly performed. However, in this instance, suitable program and tuning are preferably added in order to avoid collision with an existing pointing dragging input.

When tapping the B point that is the previous point and then touching and dragging the C point within a predetermined time, the direction key is operated in a direction C, and when touching and dragging the C point after elapse of the predetermined time, the direction key is not operated and a mouse pointing may be operated.

In addition, when a position of the C point on which touching and dragging is performed is within a set interval with a position of the B point, the direction key is operated, and when dragging is performed in a position spaced apart from each other by the set interval or more, a mouse pointing mode is operated and a cursor displayed on a screen may be moved. In this instance, a method of appropriately combining the set time other than the set interval or the set time and interval may be applied in various ways.

As another method, a drag type may be distinguished. That is, touch-dragging having linear directivity which has been subjected to direction key tap generates consecutive direction key signals, and when a dragging direction is changed to an arc or by a set angle or more, a method of converting into a mouse cursor movement may be implemented. In addition, in a case of inputting consecutive direction key input signals through linear dragging, when the dragging angle is changed while having linearity, direction key movement rather than mouse cursor movement may be changed. In addition, through a method in which a finger is separated from a side wall of the touch pad when reaching the side wall when performing linear dragging and then dragging is performed in a previous distance position again, consecutive direction key movement may be implemented.

Feasibility of the touch pad input method according to the present invention has been already verified through an internal touch pad sample test, and when a tap function which is widely used in a touch pad having click buttons among existing touch pad products is replaced with click buttons, a tap function region of the touch pad may be more effectively converted to be applied to the product, thereby maximizing efficiency.

### Second Embodiment

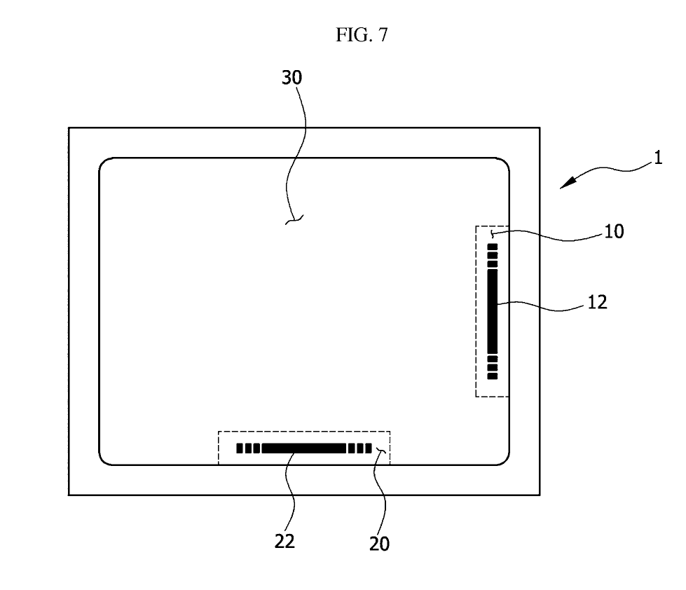

Hereinafter, a touch pad input method and input device according to a second embodiment of the present invention will be described with reference to FIGS. 7 to 11.

FIG. 7 is a diagram illustrating a touch pad 1 in a touch pad input method according to a second embodiment of the present invention.

As shown in FIG. 7, the touch pad includes a scroll region having a vertical scroll region 10 and a horizontal scroll region 20 and a cursor movement region 30.

In the present embodiment, the vertical scroll region 10 is formed at the right side of the touch pad 1, and the horizontal scroll region 20 is formed in a lower portion of the touch pad 1. However, this is merely an example, and the vertical scroll region 10 and the horizontal scroll region 20 may be formed in different positions of the touch pad 1.

In the vertical scroll region 10 and the horizontal scroll region 20, a vertical scroll 12 and a horizontal scroll 22 may be separately displayed in order to enable a user to easily recognize a corresponding region. The vertical scroll 12 and the horizontal scroll 22 may be embossed or engraved on the surface of the touch pad 1 so as to detect them even with a touch.

In addition, when the vertical scroll region 10 and the horizontal scroll region 20 are formed over the entire one side of the touch pad 1, the respective scroll regions are likely to be overlapped, and therefore in the present embodiment, the vertical scroll region 10 and the horizontal scroll region 20 are formed shorter than the entire length of the touch pad 1.

When a touch is performed in order for a user to use such a touch pad 1, a pre-determining step in which a location operation unit determines a contact position on the touch pad 1 is performed.

In the pre-determining step, a region in which a touch is performed is determined.

In this instance, when the contact position on the touch pad is outside the scroll region, a cursor movement function may be performed.

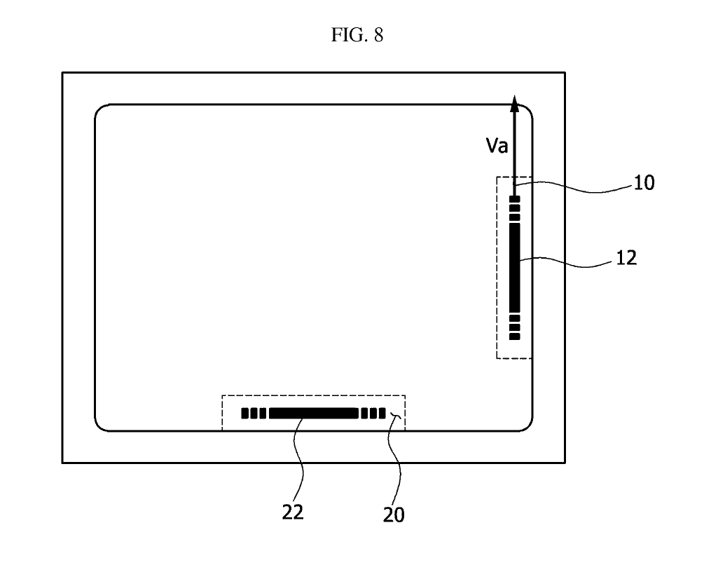

As shown in FIG. 8, when it is determined that the contact position is in any one of the vertical scroll region 10 and the horizontal scroll region 20 through the pre-determining step, a direction of primary dragging (Va) is determined, when the direction of primary dragging (Va) coincides with a longitudinal direction of the scroll region, a primary determining step in which the scroll function is performed so as to correspond the direction of primary dragging (Va) is performed.

In the primary determining step, a user determines the direction in which primary dragging is performed and then compares the compared direction with the longitudinal direction of the corresponding scroll region. That is, in a case in which an initial touch position is formed in the vertical scroll region 10, when the primary dragging (Va) is performed in any one of an upward direction and a downward direction, scrolling in the corresponding direction may be performed. In addition, in a case in which the initial touch position is formed in the horizontal scroll region 20, when the primary dragging (Va) is performed in any one of a left direction or a right direction, scrolling in the corresponding direction may be performed.

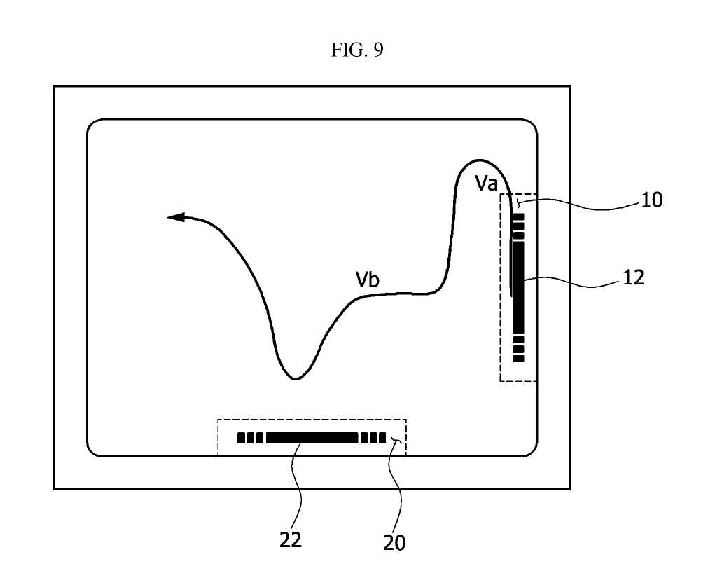

Next, as shown in FIG. 9, a secondary determining step in which the direction of secondary dragging (Vb) input in connection with the primary dragging (Va) is determined and when the direction of secondary dragging (Vb) has a vector component in a direction perpendicular to the direction of primary dragging (Va), a current scrolling direction is maintained is performed.

In the secondary determining step, a touch position is moved to an edge portion of the touch pad when a user performs the primary dragging (Va), and in this instance, the secondary dragging (Vb) is performed in order to maintain scrolling. Next, whether the direction of secondary dragging (Vb) has the vector component in the direction perpendicular to the direction of primary dragging (Va) is determined.

As shown in FIG. 9, in the present embodiment, the secondary dragging (Vb) is moved in the left direction from the primary dragging (Va) that is an upper direction. That is, the secondary dragging (Vb) has the vector component in the direction perpendicular to the direction of the primary dragging (Va) that is the upper direction, and therefore scroll input may be maintained in the direction in which scrolling is currently performed.

In this manner, in the primary determining step and secondary determining step, the primary dragging (Va) and the secondary dragging (Vb) may perform the scroll function even when deviated from a scroll region in which scrolling is started.

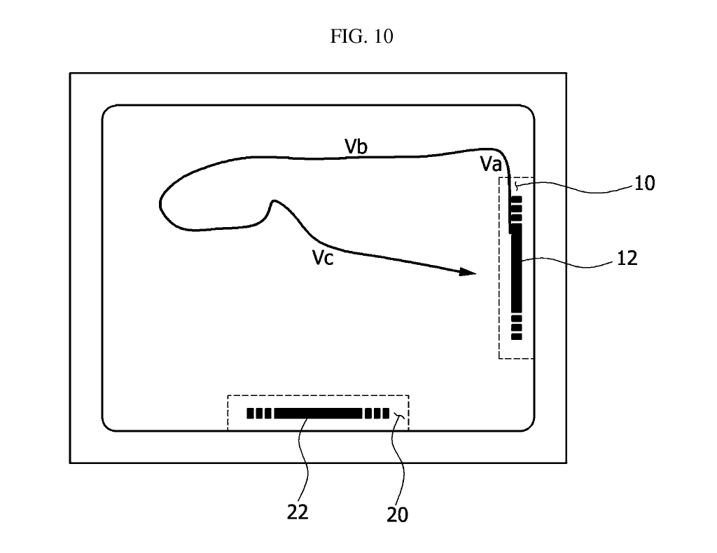

Next, as shown in FIG. 10, a tertiary determining step in which the direction of tertiary dragging (Vc) input in connection with the secondary dragging (Vb) is determined is performed.

In the tertiary determining step, the direction of tertiary dragging (Vc) is determined to be compared with the secondary dragging (Vb). In this instance, when the direction of tertiary dragging (Vc) has a vector component in a direction perpendicular to the direction of secondary dragging (Vb), a current scrolling direction may be maintained.

In addition, when the direction of tertiary dragging (Vc) has a vector component in a direction opposite to the direction of secondary dragging (Vb), a scroll function in the reverse direction may be performed.

That is, in the case of the tertiary determining step, when the direction of tertiary dragging (Vc) has the vector component in the direction perpendicular to the direction of secondary dragging (Vb), scrolling may be maintained, and when the direction of tertiary dragging (Vc) has the vector component in the direction opposite to the direction of secondary dragging (Vb), scrolling is reversed.

In the present embodiment shown in FIG. 10, the secondary dragging (Vb) is performed to the left side, and therefore when drag is extended upward or downward in this state, the scrolling is still maintained in the same direction. However, when the dragging direction is extended to the right side, scrolling in the reverse direction may be performed.

That is, in the present embodiment, the tertiary dragging (Vc) is performed to the right side, and therefore scrolling may be performed downward during the tertiary dragging.

In addition, in the tertiary determining step in the same manner as in the primary determining step and second determining step, the tertiary dragging (Vc) performs the scroll function even when deviated from the scroll region.

In addition, the pre-determining step may perform a cursor movement function when the contact position on the touch pad is outside the scroll region, and in this instance, the pre-determining step may continuously perform the cursor movement function even when the contact position on the touch pad is included in the scroll region.

In this manner, according to the scroll input method of the present invention, scroll-input may be continuously performed while one-time touch is maintained, and scroll-input in the reverse direction may be performed without completing touch. Next, the vector component in the dragging direction which is continuously input even after the tertiary determining step may be determined, thereby adjusting the direction of scrolling.

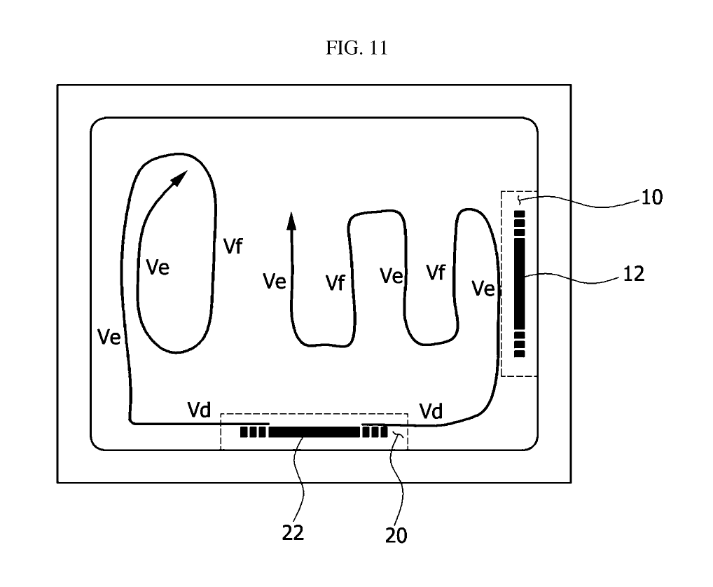

In FIG. 11, an example in which horizontal scrolling is performed using the horizontal scroll region 20 is shown.

In a case of an input method shown at the left side, primary dragging (Vd) is performed to the left side to perform scroll-input in the left direction, and then secondary dragging (Ve) is performed upward to maintain scroll-input.

Next, tertiary dragging (Vf) is performed downward to perform scroll-input in the right direction, and then dragging input thereafter is performed in the same direction as in the secondary dragging (Ve) to perform scroll in the left direction again.

That is, the input method shown at the left side performs scrolling while forming a spiral-shaped trajectory.

In a case of an input method shown at the right side, the primary dragging (Vd) is performed to the right side to perform scroll-input in the right direction, and then the second dragging (Ve) is performed upward to maintain scroll-input.

Next, the tertiary dragging (Vf) is performed downward to perform scroll-input in the left direction, and then in dragging input thereafter, the scrolling direction is consecutively changed by repeating the secondary dragging (Ve) and the tertiary dragging (Vf).

That is, the input method shown at the right side performs scrolling while forming a zigzag-shaped trajectory.

As described above, in the touch pad scroll input method according to the present invention, the entire area of the touch pad is converted into the scroll region when implementing scrolling, and therefore the scroll may be operated in a wide region. In addition, when the scroll is formed significantly long, consecutive scrolling may be implemented without repeatedly performing touch over several times.

### Third Embodiment

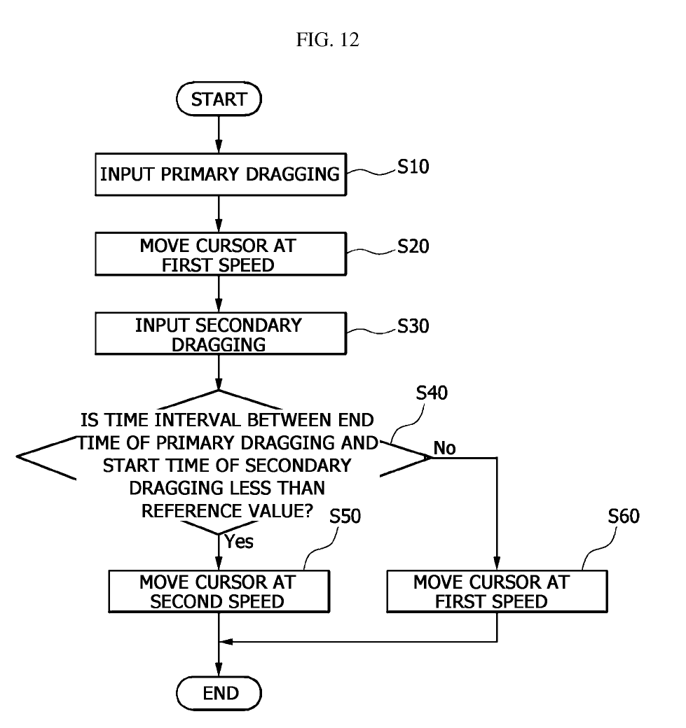

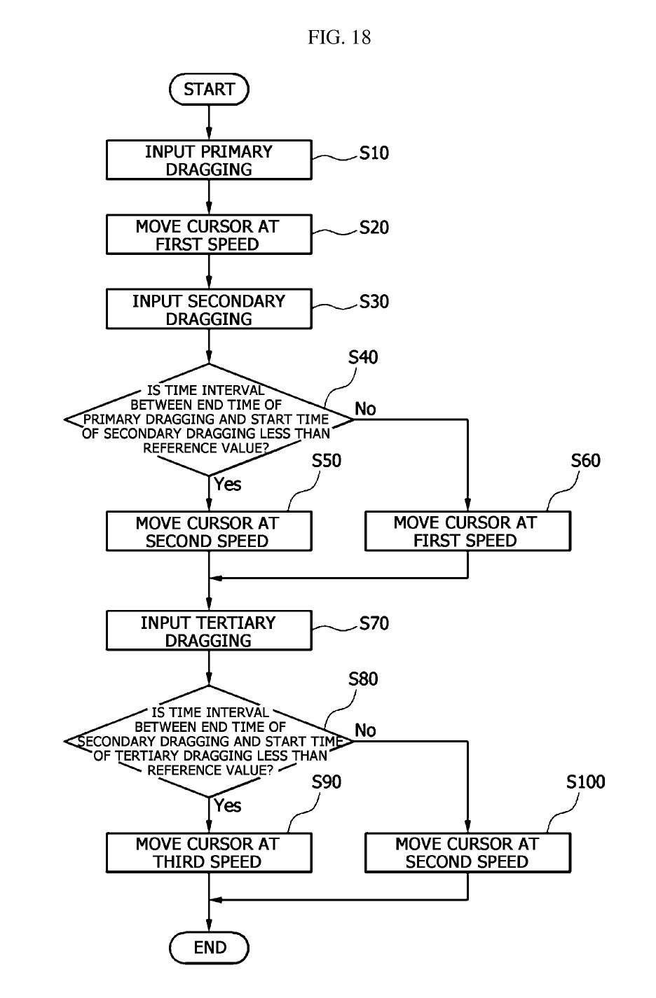

Hereinafter, a touch pad input method and input device according to a third embodiment of the present invention will be described with reference to FIGS. 12 to 20.

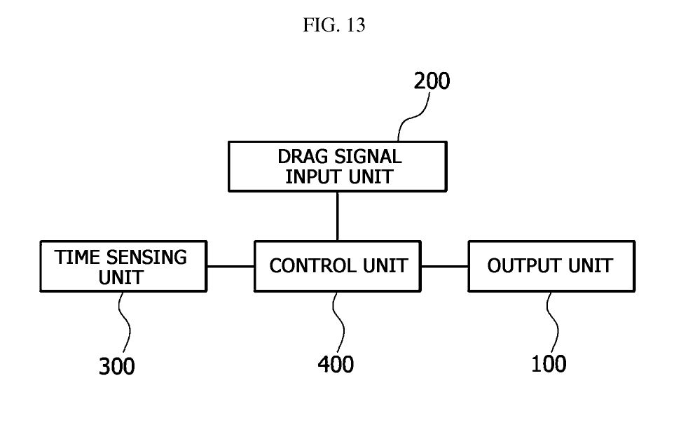

FIG. 12 is a flowchart illustrating a touch pad input method by a touch pad input device according to a third embodiment of the present invention, and FIG. 13 is a block diagram illustrating a touch pad input method by a touch pad input device according to a third embodiment of the present invention.

The touch pad input method according to the third embodiment of the present invention is a signal input method for moving a mouse cursor (hereinafter, abbreviated as “cursor 120”) through drag operations. In the touch pad input method according to the third embodiment of the present invention, a movement acceleration rate of the cursor 120 may be increased and decreased in accordance with a dragging speed, that is, a movement distance of the cursor 120 is increased and decreased in accordance with how fast dragging is performed even when dragging is performed at the same distance. One of the biggest characteristics of the third embodiment of the present invention is that the movement acceleration rate of the cursor 120 may be applied differently in accordance with the magnitude of a time interval (hereinafter, abbreviated as “drag pause period”) between an end time point of the primary dragging and a start time point of the secondary dragging when consecutively repeating dragging at least twice. That is, depending on when to input the secondary dragging after elapse of a certain period of time at the completion of the primary dragging, the movement acceleration rate of the cursor 120 may be applied differently.

In order to implement the touch pad input method, a touch pad input device including a function of sensing the above-mentioned drag pause period and a function of applying the movement acceleration rate of the cursor 120 which is different in accordance with the drag pause period is required. That is, as shown in FIG. 13, the touch pad input device according to the present invention includes a drag signal input unit 200 that receives drag signals, a time sensing unit 300 that measures the drag pause period, that is, a period between two consecutive drag signals, and a control unit 400 that outputs the movement signals of the cursor 120 in accordance with the drag signals input through the drag signal input unit 200 and increases and decreases the moving speed of the cursor 120 which is different in accordance with a length of the drag pause period. The control unit 400 moves the cursor 120 in accordance with a first increase/decrease rate when the length of the drag pause period is in a set range, and moves the cursor 120 in accordance with a second increase/decrease rate different from the first increase/decrease rate when a time interval of two consecutive drag singles is outside a predetermined set range, and therefore a user may obtain the movement speed and movement distance of the cursor 120 depending on that the secondary dragging is started after how much time passed from the end time point at which the primary dragging is completed even when dragging is performed at the same distance and same speed.

As shown in FIG. 12, the touch pad input method using the touch pad input device configured as above includes a first step S10 in which primary dragging is input, a second step S20 in which the control unit 400 moves the cursor 120 output to an output unit 100 in accordance with the first increase/decrease rate allocated to the primary dragging, a third step S30 in which secondary dragging is input to the drag signal input unit 200 after the primary dragging is completed, a fourth step (S40) in which the time sensing unit 300 senses a length of the drag pause period and the control unit 400 determines whether the drag pause period is in a predetermined setting range, and fifth steps S50 and S60 in which the cursor 120 is moved in accordance with the second increase/decrease rate allocated to the secondary dragging when the drag pause period is in the predetermined setting range and the cursor 120 is moved in accordance with the first increase/decrease rate when the drag pause period is outside the setting range.

In this instance, the drag pause period generated when consecutively performing dragging at least twice is shown differently by individual differences of users, and therefore a setting range of the drag pause period is preferably set directly by a user.

In addition, the movement speed of the cursor 120 includes a first speed and a second speed different from each other. Here, the second speed may be set faster than the first speed, or the second speed may be set slower than the first speed. Hereinafter, in the embodiment of the touch pad input method according to the present invention, only a case in which the second speed is set faster than the first speed is described, but the first speed and the second speed may be freely changed in accordance with various conditions.

Hereinafter, a use example of the touch pad input method according to the present invention will be described in detail.

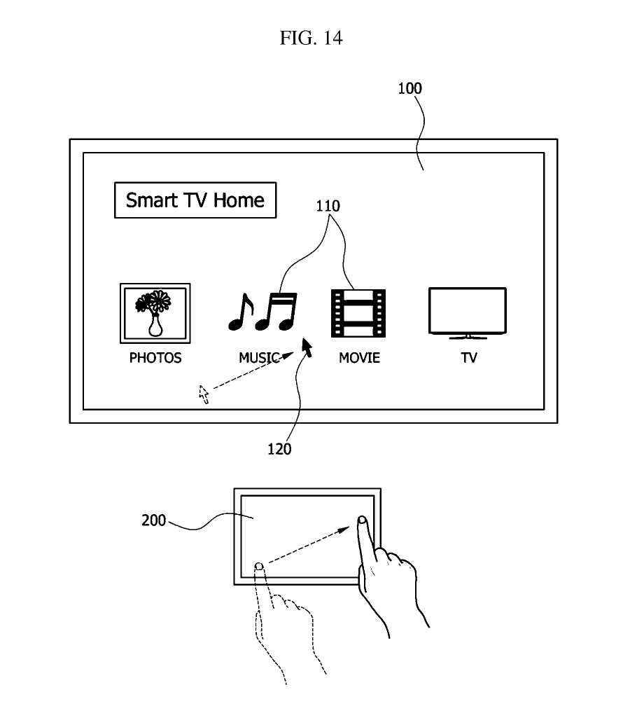

FIGS. 14 to 17 are diagrams illustrating a cursor movement process in accordance with a touch pad input method by a touch pad input device according to a third embodiment of the present invention.

In the touch pad input method according to the present invention based on the fact that dragging is repeatedly input over twice or more, when a user performs dragging on the drag signal input unit 200 such as the touch pad or the like as shown in FIG. 14 using the user's finger, the cursor 120 output to the output unit 100 is moved in a dragging direction applied by the user. In this instance, the drag signal input unit 200 has a significantly small size than the output unit 100, and therefore when the cursor 120 is set to be moved by a dragging distance, dragging should be repeated over several times in order to move the cursor 120 from the upper left end above the output unit 100 to the right end, whereby inconvenience is caused.

Thus, in the touch pad input method which is currently commercialized, the cursor 120 is moved by a distance corresponding to several times of the dragging distance when dragging is applied, and the speed of the cursor 120 is set to be increased at an increase rate higher than an increase rate of the dragging speed when the dragging speed is increased. The primary dragging applied to the present invention and movement of the cursor 120 in accordance with the primary dragging may be substantially the same as dragging and movement of the cursor 120 according to the conventional touch pad input method, and thus detailed descriptions thereof will be omitted.

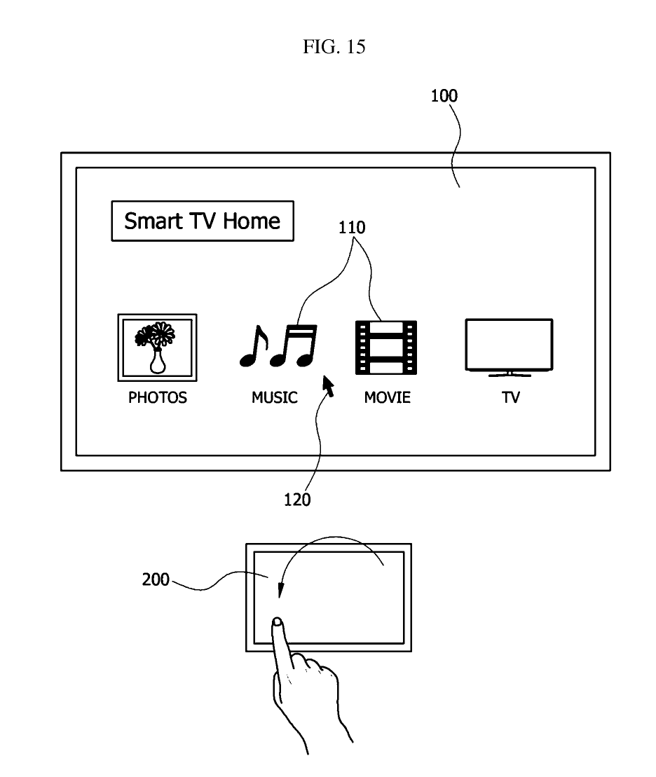

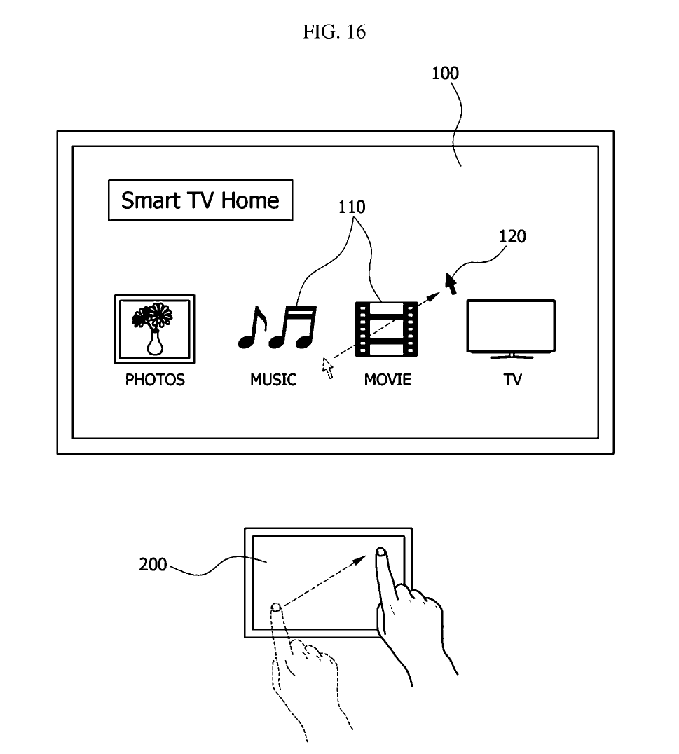

As shown in FIG. 14, when the cursor 120 which is positioned in the left lower end above the output unit 100 is to be positioned in an ‘MOVIES’ icon 110 positioned in the right upper end, the cursor 120 should be moved to the right upper side by inputting dragging in the drag signal input unit 200 to the right upper side. In this instance, when a user's finger is positioned in an edge portion of the drag signal input unit 200 in a state in which the cursor 120 still does not reach the “MOVIES” icon 110, dragging cannot be performed any more, and therefore as shown in FIG. 15, the user's finger should be returned to an initial position and then dragging should be additionally input. When a movement condition when the secondary dragging is input in the state shown in FIG. 15 is set in the same manner as the movement speed of the cursor 120 when the primary dragging is input, that is, when the cursor 120 of the output unit 100 is set so as to be moved quickly and to a distance even though dragging is input short in the drag signal input unit 200, the cursor 120 may pass by the “MOVIES” icon 110 as shown in FIG. 16, and therefore dragging in the reverse direction (left downward) should be input again. In particular, in a case of a user unfamiliar to the drag signal input, it is difficult to accurately position the cursor 120 in the “MOVIES” icon 110 even when dragging is performed over several times.

Obviously, when drag sensitivity is reduced so that the movement speed of the cursor 120 by dragging is lowered, the cursor 120 may be more easily positioned in a desired point, but in order to move the cursor 120 to a distance, dragging should be repeatedly input several times.

In the touch pad input method according to the present invention, the cursor 120 is moved at a different speed even when dragging is performed at the same speed and the same distance, and therefore drag input frequency may be reduced by increasing the movement speed of the cursor 120 when moving the cursor 120 to a distance, and movement of the cursor 120 may be facilitated by reducing the movement speed of the cursor 120 when the position of the cursor 120 is required to be finely adjusted.

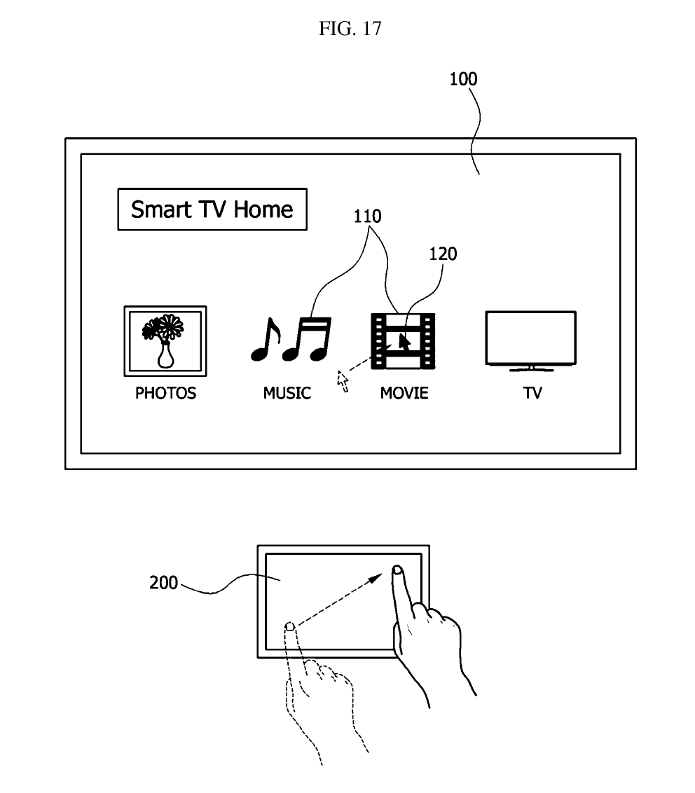

For example, as shown in FIG. 14, when the secondary dragging is input at a time point when one second or more elapses after the primary dragging is input, the cursor 120 is moved quickly as shown in FIG. 16, and when the secondary dragging is input within one second after the primary dragging is input, the cursor 120 is slowly moved to be accurately positioned in a target point (in the present embodiment, the “MOVIES” icon 110) as shown in FIG. 17. In this manner, when the movement speed of the cursor 120 is changed in accordance with a drag pattern change, a user quickly moves the cursor 120 until reaching a peripheral portion of the icon 110 desired to reach by the cursor 120, thereby reducing dragging frequency. After the cursor 120 reaches the icon 110 desired to be selected, the cursor 120 may be gradually moved to perform accurate movement of the cursor 120, and therefore significantly convenient movement operations of the cursor 120 may be achieved. In particular, when an area of the output unit 100 is large and a large number of icons 110 are output such as in the smart TV, using the touch pad input method according to the present invention, the user's desired icon 110 may be more quickly and accurately selected.

In the present embodiment, only a case in which a setting range of the drag pause period is set as one second or more and then the cursor 120 is slowly moved when the secondary dragging is input after elapse of one second at the end time point when the primary dragging is completed has been described, but the setting range of the drag pause period may be set as less than one second, or set as a period having a lower limitation and an upper limitation such as “one second or more and less than two seconds”. In this manner, the setting range of the drag pause period may be set in various ways in accordance with various conditions such as characteristics, application, and the like of the product, and detailed description of the drag pause period will be omitted.

In addition, in the present embodiment, only a case in which the movement speed increase/decrease rate of the cursor 120 is reduced when the secondary dragging is input within the setting range of the drag pause period has been described, but the movement speed increase/decrease rate of the cursor 120 may be set to be increased when the secondary dragging is input within the setting range of the drag pause period, or may be set so that the cursor 120 is more quickly moved. The magnitude of the initial movement speed increase/decrease rate (first increase/decrease rate) of the cursor 120 and the magnitude of the movement speed increase/decrease rate (second increase/decrease rate) when the secondary dragging is input within the setting range of the drag pause period may be freely set in accordance with characteristics, applications, and the like of the product to which the touch pad input method according to the present invention is applied. However, generally, an operation of inputting the drag signals to move the cursor 120 may be widely utilized for selecting a specific icon 110 after moving the cursor 120, and thus the second increase/decrease rate is preferably set to be lower than the first increase/decrease rate.

In addition, in the present embodiment, it is determined that the primary dragging is completed when a contact means (in the present embodiment, user's finger) is separated from the drag signal input unit 200 after the primary dragging is completed, but it may be determined that the primary dragging is completed when the contact means stops without moving for a certain period of time or more even though the contact means is brought into contact with the drag signal input unit 200 after the primary dragging. In this manner, when it is determined that the primary dragging is completed even when the contact means is brought into contact with the drag signal input unit 200, the movement speed of the cursor 120 may be freely increased and decreased in such a manner that the user stops for a moment the contact means on which dragging is performed and then performs dragging again, whereby an operation for movement of the cursor 120 may be more simplified.

In addition, the movement speed increase/decrease rate of the cursor 120 by dragging may be set differently in accordance with a start point position of the dragging. For example, when desiring to move the cursor 120 to a distance, the start point of the dragging is set in a peripheral portion of the drag signal input unit 200 so that long-dragging is performed at one time, and when desiring to slightly move the cursor 120, there is no need to perform long-dragging and therefore the start point of the dragging is generally set in a center portion of the drag signal input unit 200. Thus, preferably, in a case in which dragging is started in the peripheral portion of the drag signal input unit 200, even when the dragging is performed at the same speed, the movement speed increase/decrease rate of the cursor 120 may be set to be increased so that the cursor 120 is quickly moved, and in a case in which dragging is started in the center portion of the drag signal input unit 200, even when the dragging is performed at the same speed, the movement speed increase/decrease rate of the cursor 120 is set to be reduced so that the cursor 120 is slowly moved.

Obviously, as opposed to the above-described case, the movement speed increase/decrease rate may be set to be increased when the dragging is started from the center portion of the drag signal input unit 200, and the movement speed increase/decrease rate may be set to be reduced when the dragging is started from the peripheral portion of the drag signal input unit 200.

Hereinafter, the flowchart of another example of the touch pad input method by the touch pad input device according to a third embodiment of the present invention will be described.

The other example of the touch pad input method according to the third embodiment of the present invention may be applied to even a case in which dragging is applied at least three times.

That is, the touch pad input method according to the present invention may further include a sixth step S70 in which tertiary dragging is applied to the drag signal input unit 200 after the fifth steps S50 and S60 in which the cursor 120 is moved in accordance with secondary drag input, a seventh step S90 in which the time sensing unit 300 senses a time interval (hereinafter, abbreviated as “additional drag pause period”) between the end time point of the secondary dragging and the start time point of the tertiary dragging and the control unit 400 determines whether the additional drag pause period is in a setting range set in advance, and eighth steps S90 and S100 in which the cursor 120 is moved in accordance with a third increase/decrease rate allocated to the tertiary dragging when the additional drag pause period is in the setting range and the cursor 120 is moved in accordance with the second increase/decrease rate when the drag pause period is outside the setting range.

In this manner, when the movement speed of the cursor 120 is set in accordance with another increase/decrease rate in a case in which the tertiary dragging is applied, the movement speed of the cursor 120 when performing the primary dragging, the movement speed of the cursor 120 when performing the secondary dragging, and the movement speed of the cursor 120 when performing the tertiary dragging may be set differently from each other, and therefore movement of the cursor 120 may be distinguished in more detail to be controlled. In this instance, a process in which the movement speed of the cursor 120 is set when the tertiary dragging is applied may be substantially the same as a process in which the movement speed of the cursor 120 is set when the secondary dragging is applied, and thus detailed description thereof will be omitted. Meanwhile, in the present embodiment, only a case in which dragging up to the tertiary dragging is performed has been described, but the touch pad input method according to the present invention may be equally applied to a case in which dragging is performed four times or more.

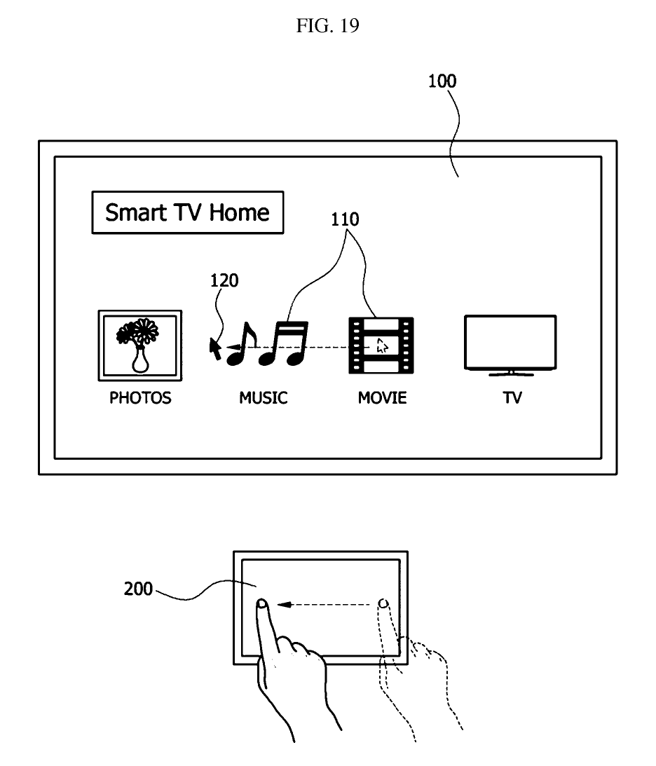

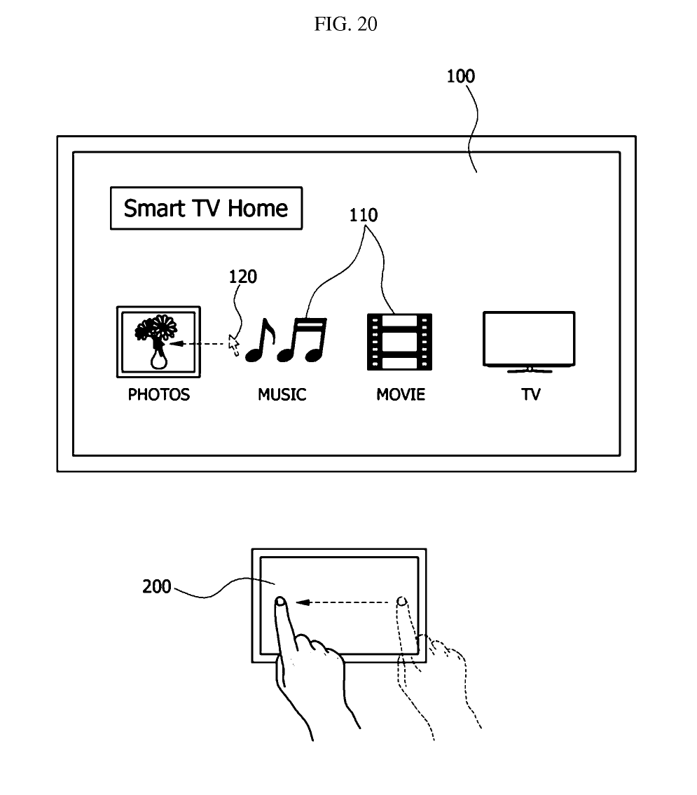

FIGS. 19 and 20 are diagrams illustrating another cursor movement process in accordance with a touch pad input method by a touch pad input device according to a third embodiment of the present invention.

In the touch pad input method according to the present invention, when all processes after the movement speed of the cursor 120 is changed by the secondary dragging are completed, the movement speed of the cursor 120 is returned to an initial rapid speed in the state shown in FIG. 17, and therefore when the cursor 120 is moved in a different direction in the state shown in FIG. 17, the cursor 120 may not be delicately moved. However, when the cursor 120 is moved at a speed by the second increase/decrease rate or the third increase/decrease rate in accordance with a length of the additional drag pause period when the tertiary dragging is applied, the cursor 120 may be prevented from being moved at the initial rapid speed.

For example, in a case in which the tertiary dragging is performed in the state shown in FIG. 17, when the additional drag pause period exceeds the setting time, that is, when the tertiary dragging is applied at a time point when one second elapses after the secondary dragging is completed, the cursor 120 may be moved at the speed (movement speed of the cursor 120 in FIG. 6) by the second increase/decrease rate, and when the additional drag pause period does not exceed the setting time, that is, when the tertiary dragging is applied within one second after the secondary dragging is completed, the cursor 120 may be moved at a speed (the slowest speed in the present embodiment) by the third increase/decrease rate. In this manner, in a case in which the cursor 120 is not moved at the speed by the first increase/decrease rate when the tertiary dragging is applied and the cursor 120 is moved at the speed by the second increase/decrease rate or the third increase/decrease rate, the cursor 120 may be delicately moved as the dragging is repeated, thereby improving accuracy of selection of the icon 110 using the cursor 120. In this instance, in the present embodiment, only a case in which the second increase/decrease rate is lower than the first increase/decrease rate and the third increase/decrease rate is lower than the second increase/decrease rate has been described, but the first increase/decrease rate, the second increase/decrease rate, and the third increase/decrease rate may be freely changed in accordance with a user's selection.

As described above, according to the touch pad input method and input device of the first embodiment of the present invention, cursor movement, scrolling, and direction key movement which have been functioned in a touch pad formed in an existing laptop may be simultaneously implemented in the touch pad, thereby increasing use convenience. In particular, when using the touch pad of the present invention together with a product without direction keys on a keyboard, the effect may be doubled. A direction display portion or the like of touch keys has a limitation in simplification of design with a trend in which design of electronic products are gradually simplified. However, since the touch pad according to the touch pad input method and input device includes direction keys in the relative coordinate method, there is no need to expose a direction display unit, and therefore a touch pad product may have an aesthetic effect and design of the touch pad product may be simplified. In addition, when the direction key function is satisfactorily implemented, various additional functions such as scrolling of menus, and the like as well as channel movement and volume adjustment in a smart TV may be implemented in the touch pad, thereby increasing convenience of use,

According to the touch pad input method and input device of the second embodiment of the present invention, a scroll allocation region on the touch pad may be minimized, and therefore the entire area of the touch pad may be efficiently utilized when the cursor is moved. Vertical scrolling and horizontal scrolling may be simultaneously allocated when scrolling is performed, and therefore scrolling of the touch pad may be performed in the same direction as a scroll direction of a display. In addition, when implementing scrolling, the entire area of the touch pad may be converted into a scroll region, and therefore scrolling may be performed in a wide area. When the scroll region is formed long in accordance with contents, scrolling may be consecutively implemented without repeatedly touching several times.

According to the touch pad input method and input device of the third embodiment of the present invention, the moving speed of the cursor may be accelerated and decelerated through an increase/decrease in the dragging speed, and therefore the cursor may be moved to a distance even when short dragging is performed. Even when dragging is performed at the same speed and the same distance, an acceleration rate of the cursor may be set differently in accordance with a cycle in which dragging is repeated, and therefore the cursor may be accurately located in a target point.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A touch pad input method comprising:
touching a first point of a touch surface of a touch pad;
touching a second point of the touch surface; and
operating a direction key based on a relative position of the first point and the second point.

2. The touch pad input method of claim 1, wherein the touching of the first point includes:
converting a current mode to a direction key input mode by touching the first point; and
setting the direction key operated for each direction with respect to the first point, and
wherein, when the touching of the second point is performed within a region in a set direction, the direction key corresponding to the direction is operated.

3. The touch pad input method of claim 1, further comprising operating, when touch of another point is additionally performed after the touching of the second point, the direction key based on a relative position of the additionally touched point and a touch point immediately before the additionally touched point.

4. The touch pad input method of claim 1, wherein the direction key is set to move a cursor vertically and horizontally with respect to the first point.

5. The touch pad input method of claim 1, wherein the direction key is set to execute increase and decrease in a channel and a volume horizontally and vertically with respect to the first point.

6. The touch pad input method of claim 1, wherein the operating of the direction key is consecutively performed when another touch is performed within a predetermined region with respect to at least one of the first point and the second point within a preset time.

7. The touch pad input method of claim 1, wherein the direction key is operated faster than when touching the second point when dragging is performed within the region in the set direction instead of touching the second point.

8. The touch pad input method of claim 7, wherein the operating of the direction key by the previous dragging is consecutively performed when dragging is performed again within a certain time in a state in which the touch on the touch surface of the touch pad is canceled to complete dragging.

9. The touch pad input method of claim 1, wherein an operating speed of the direction key is increased and decreased based on a time for which the touching of the second point is maintained.

10. The touch pad input method of claim 1, wherein, when a switch capable of recognizing a click is mounted on a bottom surface of the touch pad, click signals and tap signals are separately generated in accordance with ON/OFF signals of the switch.

11. A touch pad input method comprising:
touching, by direction keys operated for each of a plurality of divided regions, a first point being one point of the divided region of a touch surface of a predetermined touch pad so that the direction key corresponding to a region in which the first point is touched is operated; and
touching a second point of the touch surface so that the direction key set based on a relative position of the first point and the second point is operated.

12. The touch pad input method of claim 11, wherein the touching of the first point includes:
touching the first point so that the direction key corresponding to the region in which the first point is touched is operated in advance; and
setting again the direction key operated for each direction with respect to the first point, and
wherein, when the touching of the second point is performed within a region in a set direction in the setting again of the direction key, the direction key corresponding to the direction is operated.

13. The touch pad input method of claim 11, further comprising operating, when touch of another point is additionally performed after the touching of the second point, the direction key based on a relative position of the additionally touched point and a touch point immediately before the additionally touched point.

14. The touch pad input method of claim 11, wherein the direction key is set to move a cursor vertically and horizontally with respect to the first point.

15. The touch pad input method of claim 11, wherein the direction key is set to execute increase and decrease in a channel and a volume horizontally and vertically with respect to the first point.

16. The touch pad input method of claim 11, wherein the operating of the direction key is consecutively performed when another touch is performed within a predetermined region with respect to at least one of the first point and the second point within a preset time.

17. The touch pad input method of claim 11, wherein the direction key is operated faster than when touching the second point, when dragging is performed within the region in the set direction instead of touching the second point.

18. The touch pad input method of claim 17, wherein the operating of the direction key by the previous dragging is consecutively performed, when dragging is performed again within a certain time in a state in which the touch on the touch surface of the touch pad is canceled to complete dragging.

19. The touch pad input method claim 11, wherein an operating speed of the direction key is increased and decreased based on a time for which the touching of the second point is maintained.

20. The touch pad input method of claim 11, wherein, when a switch capable of recognizing a click is mounted on a bottom surface of the touch pad, click signals and tap signals are separately generated in accordance with ON/OFF signals of the switch.
